(19) United States
(12) Patent Application Publication
(10) Pub. No.: US 2013/0218952 A1
(43) Pub. Date: Aug. 22, 2013

(54) DOCUMENT RESTORATION METHOD BY CONVERGED ADDRESS BOOK SERVER AND CONVERGED ADDRESS BOOK CLIENT TERMINAL FOR THE DOCUMENT RESTORATION METHOD

(71) Applicant: Samsung Electronics Co., Ltd., (US)

(72) Inventors: Gyu-Bong OH, Gyeonggi-do (KR); Wuk Kim, Gyeonggi-do (KR); Kyung-Tak Lee, gyeonggi-do (KR)

(73) Assignee: Samsung Electronics Co., Ltd., Gyeonggi-do (KR)

(21) Appl. No.: 13/754,131

(22) Filed: Jan. 30, 2013

(30) Foreign Application Priority Data
Feb. 16, 2012 (KR) 10-2012-0015995

(51) Int. Cl. H04L 29/06

(52) U.S. Cl. CPC H04L 29/06047
USPC 709/203

(57) ABSTRACT

Provided is a document restoration apparatus and method based on a Converged Address Book (CAB) service, which includes acquiring document change information from a CAB document management server in response to a document restoration request by a client, determining a restoration target document based on the acquired document change information, and restoring a deleted document in the CAB document management server by providing the document restoration request for the determined restoration target document to the CAB document management server. Therefore, it is possible to efficiently manage information relating to a deleted address without a separate auxiliary repository in a CAB server and at the same time, to easily restore an address.

### PRIORITY

This application claims priority under 35 U.S.C. §119(a) to a Korean Patent Application filed in the Korean Intellectual Property Office on Feb. 16, 2012 and assigned Serial No. 10-2012-0015995, the entire disclosure of which is incorporated herein by reference.

### BACKGROUND OF THE INVENTION

1. Field of the Invention

The present invention relates generally to a Converged Address Book (CAB) service, and more particularly, to a document restoration apparatus and method based on a CAB service.

2. Description of the Related Art

With widespread use of mobile communication technology, providing and exchanging necessary information anywhere and anytime due to its portability, mobile communication technology greatly influences and changes daily life of a user. One important technical demand in a messaging service available in mobile communication technology is for more convenient message transmission to several recipients and more rapid and accurate updating of address information changes of a recipient. Thus, a messaging service needs a converged management of the address book. To meet this need, a Converged Address Book (CAB) service has been proposed.

The CAB service is an address book service based on a single network which stores address information available in various terminals of users, allows access to the information anywhere and anytime with any device, and synchronizes the address information. The CAB service is intended to improve user experience and available features of an address book by storing a single network address book in the network. Main functions of the CAB service include address book synchronization, contact subscription, contact share, contact search, external address book retrieval from a non-CAB system, and the like.

To provide the CAB service, a CAB Extensible Markup Language (XML) Document Management Server (XDMS) stores user data such as a CAB. A terminal user deletes an unnecessary address and restores the deleted address when necessary, as illustrated in FIG. 1.

Referring to FIG. 1, upon receiving an address deletion request from a user, a CAB user terminal 10 sends the deletion request to a CAB server 20 which then deletes a corresponding address in an address book from a CAB Address Book (AB) Application Usage of a CAB XDMS 30 and separately stores information relating to the deleted address, such as a deletion status, and the like, as an address book history. The CAB server 20 copies the information relating to the deleted address to a backup storage unit 25 of the CAB server 20.

Thereafter, upon receiving an address restoration request from the user, the CAB user terminal 10 sends the address restoration request for a deleted address to the CAB server 20. The CAB server 20 then sets information relating to the deleted address to a normal status, and adds the deleted address to an address book of the CAB XDMS 30.

However, the conventional address restoration method described above requires a separate auxiliary repository in a CAB server for history management of deleted address information. Moreover, a history of the deleted address information stored in the auxiliary repository of the CAB server is also managed in the CAB Application Usage of the CAB XDMS, which is the original repository, resulting in redundant information stored in different repositories. In addition, for address deletion and restoration, the CAB server requires additional processes such as history storage, address status setting, or the like, resulting in performance degradation due to execution of the additional processes.

Therefore, there is a need for a method capable of easily restoring an address while efficiently managing information relating to deleted addresses, without a separate auxiliary repository in a CAB server.

### SUMMARY OF THE INVENTION

Accordingly, the present invention has been made to solve the above-stated problems and/or disadvantages and to provide at least the advantages described below. Accordingly, an aspect of the present invention is to provide an apparatus and method for efficiently restoring a deleted document based on a CAB service.

According to an aspect of the present invention, there is provided an apparatus and method for easily restoring an address while managing information relating to a deleted address, if the deleted document is an address, based on a CAB service.

According to an aspect of the present invention, there is provided a document restoration method by a Converged Address Book (CAB) server, the document restoration method including acquiring document change information from a CAB document management server in response to a document restoration request by a client, determining a restoration target document based on the acquired document change information, and restoring a deleted document in the CAB document management server by providing the document restoration request for the determined restoration target document to the CAB document management server.

According to another aspect of the present invention, there is provided a Converged Address Book (CAB) client terminal for document restoration, the CAB client terminal including a storage unit for storing a deleted-document list comprising version information of at least one deleted documents and a controller for acquiring version information of a deleted document from a CAB server as document deletion is requested, storing the acquired version information, and upon selection of a restoration target document from the stored deleted-document list, transmitting a document restoration request to the CAB document management server for the CAB server to restore the selected restoration target document in the CAB document management server.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a conventional document deletion scheme;

FIG. 2 is a diagram illustrating a CAB system, according to an embodiment of the present invention;

FIG. 3 is a diagram illustrating a document deletion process, according to an embodiment of the present invention;

FIG. 4 is a diagram illustrating an example of a Data Synchronization (DS) message for transmitting document change information of FIG. 3, according to an embodiment of the present invention;

FIG. 5 is a diagram illustrating an example of an XML Configuration Access Protocol (XCAP) request message for a document deletion request of FIG. 3, according to an embodiment of the present invention;

FIG. 6 is a diagram illustrating an example of a XCAP response message corresponding to a document deletion request of FIG. 3, according to an embodiment of the present invention;

FIG. 7 is a diagram illustrating an example of a DS message for transmitting document modification information of FIG. 3, according to an embodiment of the present invention;

FIG. 8 is a diagram illustrating definition of an additional element in a DS message, according to an embodiment of the present invention;

FIG. 9 is a diagram illustrating an example of a modification history information document, according to an embodiment of the present invention;

FIG. 10 is a diagram illustrating a document restoration process according to an embodiment of the present invention;

FIG. 11 is a diagram illustrating an example of a document restoration request from a CAB client of FIG. 10, according to an embodiment of the present invention;

FIG. 12 is a diagram illustrating an example of a document restoration request from a CAB server of FIG. 10, according to an embodiment of the present invention;

FIG. 13 is a diagram illustrating an example of a response message corresponding to a document restoration request from a CAB client of FIG. 10, according to an embodiment of the present invention;

FIG. 14 is a diagram illustrating a document restoration process according to an embodiment of the present invention;

FIG. 15 is a diagram illustrating definition of another additional element in a DS message, according to an embodiment of the present invention;

FIG. 16 is a diagram illustrating an example of a DS message for a document replacement request of FIG. 14, according to an embodiment of the present invention; and

FIG. 17 is a diagram illustrating an example of a DS message for status report corresponding to a document restoration request of FIG. 14, according to an embodiment of the present invention.

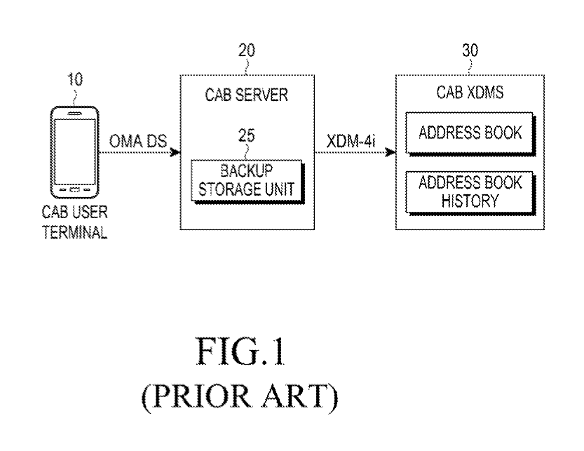

### DETAILED DESCRIPTION OF THE EMBODIMENTS OF THE PRESENT INVENTION

Hereinafter, various embodiments of the present invention are described with reference to the accompanying drawings. In the following description, like reference numerals refer to like elements, features and structures, throughout the drawings. Detailed description of known functions and structures is omitted to avoid obscuring the subject matter of the present invention. Names of objects defined in a standard organization for applications of mobile terminals, such as the Converged Address Book (CAB) of the Open Mobile Alliance (OMA), will be used, but the standard and the names are not intended to limit the scope of the present invention and the present invention is applicable to a system having a similar technical background.

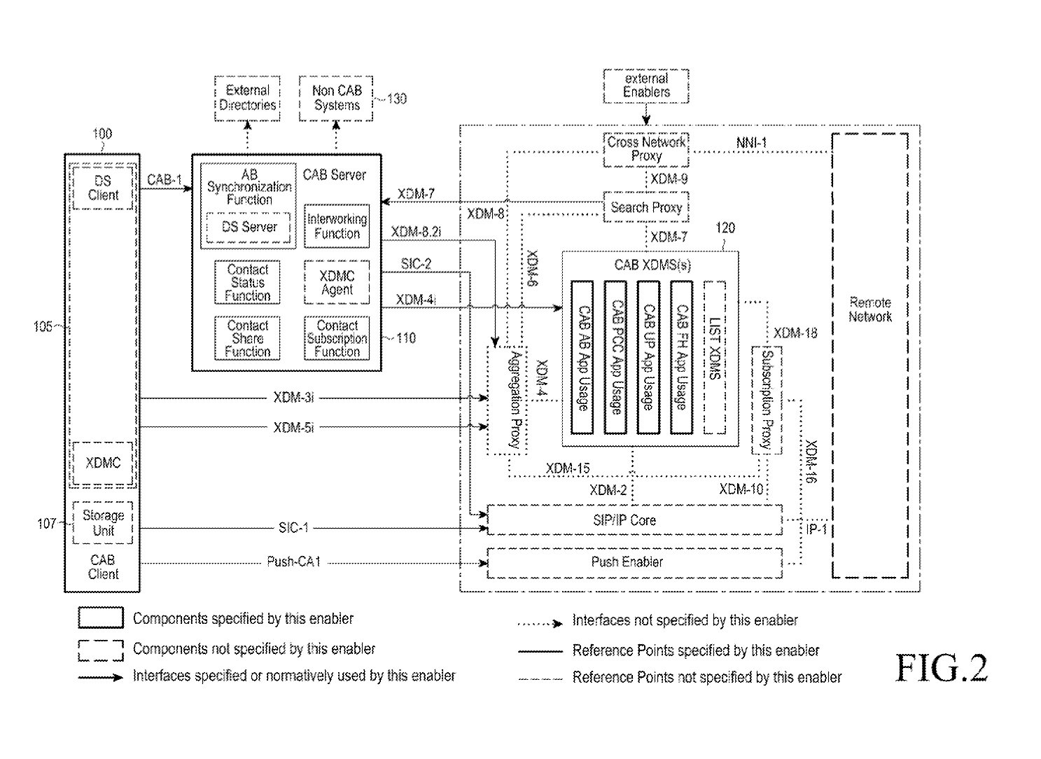

Considering the conceptual structure of the OMA CAB with reference to FIG. 2, a CAB service system includes a CAB client 100, a CAB server 110, a CAB XML Document Management Server (XDMS) (CAB XDMS) 120, and a non-CAB system 130.

The CAB client 100 is implemented on a terminal carried by a user, and on the terminal, the CAB client 100 communicates with the CAB server 110, performs CAB user authentication and synchronization between Personal Contact Card (PCC) information and a CAB stored in a network repository, and transmits CAB user requests, for example, address subscription, address search, address share, interaction with an existing address book, or user preference management, to the CAB server 110.

Specifically, the CAB client 100 according to an embodiment of the present invention transmits a document deletion request and a document restoration request at the request of a CAB user. The CAB client 100, upon requesting document deletion, acquires status information including version information of a deleted document from the CAB server 110. As such, the CAB client 100, whenever requesting document deletion, acquires the version information of the deleted document, and stores the acquired version information in a storage unit 107. Thus, a deleted-document list having different version information for different deleted documents is stored in the storage unit 107 of the CAB client 100 and a user of the CAB client 100, when desiring to restore a document, needs to only select a restoration target document from the deleted-document list. The CAB client 100 then requests document restoration by using version information of the document corresponding to the selection.

The CAB client 100 includes a controller 105 which acquires the version information of the deleted document from the CAB server 110 in response to a user's request for document deletion and stores the acquired version information in the storage unit 107, and upon selection of the restoration target document from the stored deleted-document list, transmits a document restoration request to the CAB XDMS 120, and the CAB server 110 restores the selected restoration target document in the CAB XDMS 120. For the document restoration request and a response thereto between the CAB client 100 and the CAB XDMS 120, an XML Configuration Access Protocol (XCAP) is used.

To forward information regarding document deletion and document restoration, a Data Synchronization (DS) protocol is used between the CAB client 100 and the CAB server 110. By using the DS protocol, information relating to a deleted document is provided not only from the CAB server 110 but also from the CAB client 100. Thus, the CAB client 100 directly owns information relating to a deleted document, and the user can quickly and conveniently restore the document.

The document restoration request is directly forwarded to the CAB XDMS 120 which actually stores documents, instead of to the CAB server 110, and here, it is assumed that the CAB client 100 supports an XML address format defined in a CAB service and understands an XML schema of a CAB AB Application Usage of the CAB XDMS 120.

The CAB server 110, a main network component in a CAB structure, receives and processes CAB user requests from the CAB client 100. Main functions of the CAB server 110 include CAB client mutual authentication, CAB address storage, address information synchronization, and reflection of address information updates from an address subscription function into an address book.

The CAB server 110 includes a storage unit for storing information necessary for a document restoration method, a communicating unit for performing communication for document restoration with the CAB client 100, and a controller for controlling overall operation for performing the document restoration method with the CAB client 100. The following operations of the CAB server 110 should be understood as being performed in the controller.

More specifically, the CAB server 110 is a network component which performs address subscription/share/translation and reflects user preference/policies. Main functions of the CAB server 110 includes an address subscription function of retrieving a CAB user preference XML document from a CAB user preference and policy XDMS and receiving a CAB user's subscription request, an address share function of applying personal preferences to data received through address subscription and reflecting the data into an address book, maintaining subscription status information, and sharing the PCC or the converged address book, and an Interworking Function (IWF) of interworking with an existing address book system or exposing an interface to an external enabler.

According to an embodiment of the present invention, the CAB server 110, upon receiving a document deletion request from the CAB client 100, deletes a document corresponding to the document deletion request from among documents stored in the CAB XDMS 120.

The CAB server 110 then provides status information including version information of the deleted document to the CAB client 100, without needing to perform a separate backup process. The version information of the deleted document is used later in document restoration of the CAB client 100.

The CAB server 110, upon receiving a document restoration request including version information of a restoration target document from the CAB client 100, identifies the restoration target document based on the version information, and requests the CAB XDMS 120 to restore the restoration target document. The CAB server 110 receives the document restoration request from the CAB client 100 through the CAB XDMS 120. Here, the CAB XDMS 120 itself cannot restore the document, and the document is restored under control of the CAB server 110.

The CAB XDMS 120, which manages user's data, includes a CAB Address Book (AB) Application Usage for storing a CAB and contact status information for distinguishing a CAB user from an existing user, a CAB User Preference (UP) Application Usage for storing user's preference, a CAB PCC Application Usage for storing PCC information, and a CAB Feature Handler (FH) Application Usage for managing CAB service request and response. In addition, the CAB XDMS 120 also includes an XDMC for accessing various Application Usage functions, an SIP/IP core network for message routing with entities of an external domain, and a PUSH enabler for notification message forwarding of non-SIP terminals.

The document restoration request from the CAB client 100 is received by the CAB FH Application Usage in the CAB XDMS 120, and the CAB FH Application Usage informs the CAB server 110 of the document restoration request. The CAB server 110 forwards information relating to the restoration target document to the CAB AB Application Usage in the CAB XDMS 120, and the CAB AB Application Usage restores the document corresponding to the information relating to the restoration target document. The information relating to the restoration target document includes current version information of the restoration target document and version information to be restored thereof If the CAB server 110 directly receives the document restoration request from the CAB client 100, then the information relating to the restoration target document, included in the document restoration request, is forwarded directly to the CAB AB Application Usage.

As such, different information is stored in the CAB AB Application Usage, the CAP UP Application Usage, the CAB PCC Application Usage, and the CAB FH Application Usage of the CAB XDMS 120, and thus in the present invention, the information will be collectively referred to as documents.

In the following description, the user deletes address information stored in the CAB AB Application Usage among the plurality of Application Usages of the CAB XDMS 120, and then restores the deleted address information. The type of a document restored after being deleted includes address information, but the type of the deleted document is not necessarily limited to address information. For example, a method for the user to delete and then restore an address stored in the CAB AB Application Usage is also applicable to restoration of PCC information and a document requiring restoration in the CAB XDMS 120.

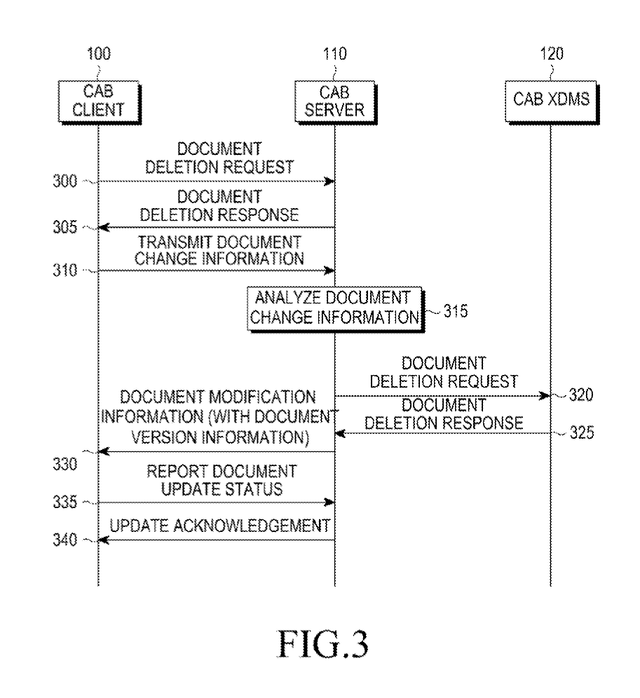

One way for a CAB client to acquire version information of a deleted document, used for document restoration, is described with reference to FIG. 3. FIG. 3 illustrates a document deletion process according to an embodiment of the present invention. Herein, for document deletion, a message according to an OMA-based DS protocol is used between the CAB client 100 and the CAB server 110.

Referring to FIG. 3, the CAB user terminal, that is, the CAB client 100 transmits a document deletion request to the CAB server 110 in response to the document deletion request of the user. For transmission of the document deletion request, a DS initialization message OMA DS Pkg #1 is used. The DS initialization message includes a synchronization related anchor, that is, Server Challenge, terminal performance information, a DS sync type, a data type, and so forth.

The CAB server 110 then transmits a document deletion response in Step 305. More specifically, the CAB server 110 generates the document deletion response, which corresponds to a challenge response and is transmitted to the CAB client 100 in the form of a DS message OMA DS Pkg #2. The DS message for the document deletion response includes a synchronization related anchor, that is, Client Challenge, server performance information, a DS sync type, and so forth.

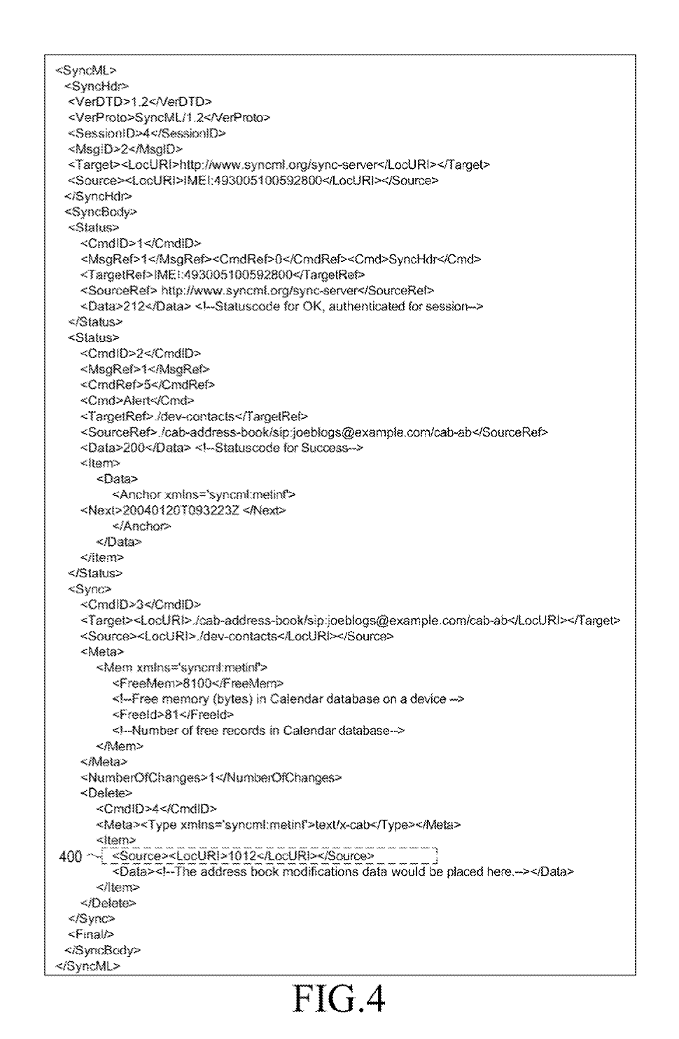

The CAB client 100, after generating a challenge response, transmits document change information in Step 310. The document change information is transmitted through a DS message OMA DS Pkg #3, and an example of the DS message including the document change information is illustrated in FIG. 4. In FIG. 4, the DS message includes document change information for deleting a document having a Local Unique ID (LUID) of “1012” as indicated by 400.

Upon receiving the DS message (OMA DS Pkg #3), the CAB server 110 analyzes the document change information included in the received DS message in Step 315. The CAB server 110 is assumed to have an item mapping table as shown in Table 1.

TABLE 1

| Client's LUID | Server's GUID | Object name |
|---|---|---|
| 990 | ABCD990 | Arun |
| 995 | ABCD995 | Basu |
| 1000 | ABCD1000 | Carole |
| 1001 | ABCD1001 | David |
| . . . | . . . | . . . |
| 1012 | ABCD1012 | Jane |
| 1013 | ABCD1013 | Kevin |

The CAB server 110 determines for which document of the AB Application Usage of the CAB XDMS 120 deletion is to be requested, by referring to the analyzed document change information and the mapping table. If the deletion target document is determined, the CAB server 110 requests deletion of the determined deletion target document from the AB Application Usage of the CAB XDMS 120 in Step 320. An XCAP is used for request and response between the CAB server 110 and the CAB XDMS 120. Thus, the document deletion request for the target document uses an XCAP deletion request message according to the XCAP.

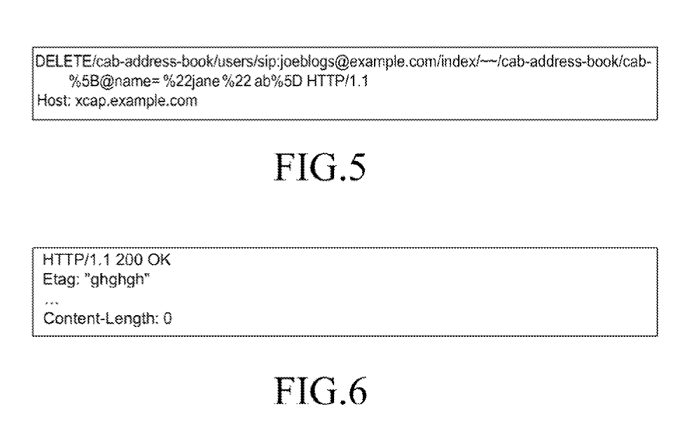

An example of the XCAP request message for the deletion request is illustrated in FIG. 5. Referring to Table 1, the CAB server 110 requests deletion of “Jane” information in an address of “joeblogs” from information stored in the AB Application Usage of the CAB XDMS 120 by using the XCAP. In FIG. 5, a deletion target document is an address “Jane”. If a received DS message includes a plurality of document change requests, the document deletion request is generated for each of the document change requests by using the XCAP. That is, a plurality of XCAP request messages as illustrated in FIG. 5 is generated.

Thus, the AB Application Usage of the CAB XDMS 120, after deleting the document for which deletion is requested, e.g., the address “Jane” transmits a document deletion response to the CAB server 110 so as to inform that the document for which deletion is requested by the CAB server 110 is actually deleted. For transmission of the document deletion response, an XCAP response message is used. While a response is transmitted regarding a single document deletion request in FIG. 3, if the AB Application Usage of the CAB XDMS 120 receives one or more document deletion requests, a response message regarding each request is generated and transmitted. An example of the XCAP response message is illustrated in FIG. 6.

The CAB server 110 then transmits status information regarding document modification to the CAB client 100 in Step 330 as the document in the CAB XDMS 120 is actually deleted. For transmission of status information regarding document modification, a DS message OMA DS Pkg #4 is used, and the CAB server 110 transmits version information of the deleted document in the Application Usage through the DS message. By forwarding the version information of the deleted document to the CAB client 100, when the user of the CAB client 100 desires to restore a document, the CAB client 100 can restore the deleted document by using the version information of the deleted document.

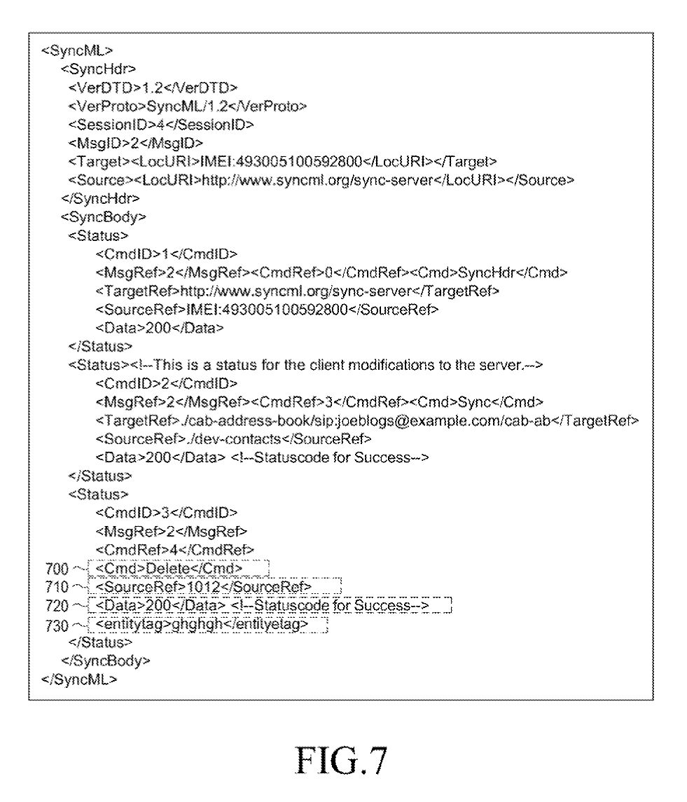

An example of the DS message including the status information is illustrated in FIG. 7. As illustrated in FIG. 7, the DS message including the status information as indicated by status code “200” 720 that a command the CAB client requests for a document “1012” 710, that is, “Delete” 700 has been successfully executed, and includes the status information indicating that the version information of the deleted document is “ghghgh” 730.

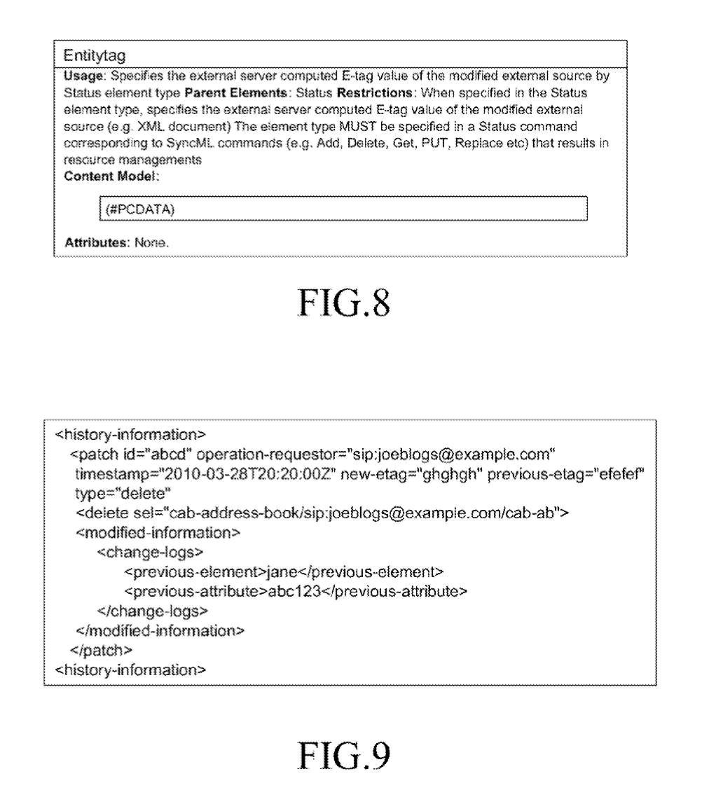

As a new common element indicating “entity tag” generated by an external server in a status element of the DS message, the present invention additionally defines an “entitytag” element. Details of the newly added “entitytag” element are as illustrated in FIG. 8.

The DS message OMA DS Pkg #4 includes status information regarding document modification, and also includes items regarding changes in the AB Application Usage after previous synchronization. Here, synchronization between the AB Application Usage and the CAB client is also possible. Thus, the CAB client 100 updates a document list, e.g., a terminal address book, through synchronization, and then in Step 335, reports a document update status to the CAB server 110. To report the document update status, a DS message OMA DS Pkg #5 is used, which includes a result and terminal/server item mapping information regarding the document update status.

Thus, the CAB server 110 transmits update acknowledgement to the CAB client 100 in Step 340. For update acknowledgement, a DS message OMA DS Pkg #6 is used, which includes update acknowledgement of an item mapping table in the CAB server 110. Steps 320 and 325 have to be completed prior to data synchronization, i.e., Step 330 or 340, to preserve data consistency.

According to an embodiment of the present invention, a method in which after the CAB client 100 directly transmits a document restoration request to the CAB XDMS 120, the CAB server 110 restores a target document in the CAB XDMS 120 is described below, and message transmission/reception between the CAB client 100 and the CAB XDMS 120 is based on an XCAP protocol. According to an embodiment of the present invention, a method in which the CAB server 110 restores a target document in the CAB XDMS 120 as the CAB client 100 transmits a document restoration request to the CAB server 110 is described below, and message transmission/reception between the CAB client 100 and the CAB server 110 is based on a DS protocol.

Before undertaking a description, the user of the CAB client 100, when desiring to restore a document, selects a restoration target document from a deleted-document list, and The CAB client 100 should have version information for each deleted document. The version information of the deleted document is previously acquired in response to a document deletion request and stored in the storage unit of the CAB client 100, or acquired in the following manner. A detailed process of acquiring the version information of the deleted document is described below.

The CAB client 100 presumes support of an XML address format, and thus can acquire version information of a deleted document from the CAB XDMS 120. More specifically, the CAB client 100 acquires a modification history information document of an AB history document including version information of deleted documents from the CAB XDMS 120, by using a DS protocol and an XCAP protocol. An example of the modification history information document is illustrated in FIG. 9. As illustrated in FIG. 9, the modification history information document includes detailed document information relating to “Jane” deleted by the user, e.g., a version (patch ID), an operation requestor, a timestamp, new document version information, previous document version information, an operation type, a document path, modification information of the modification history information document, and so forth. The CAB client 100 restores the version information of the deleted document based on the acquired modification history information document.

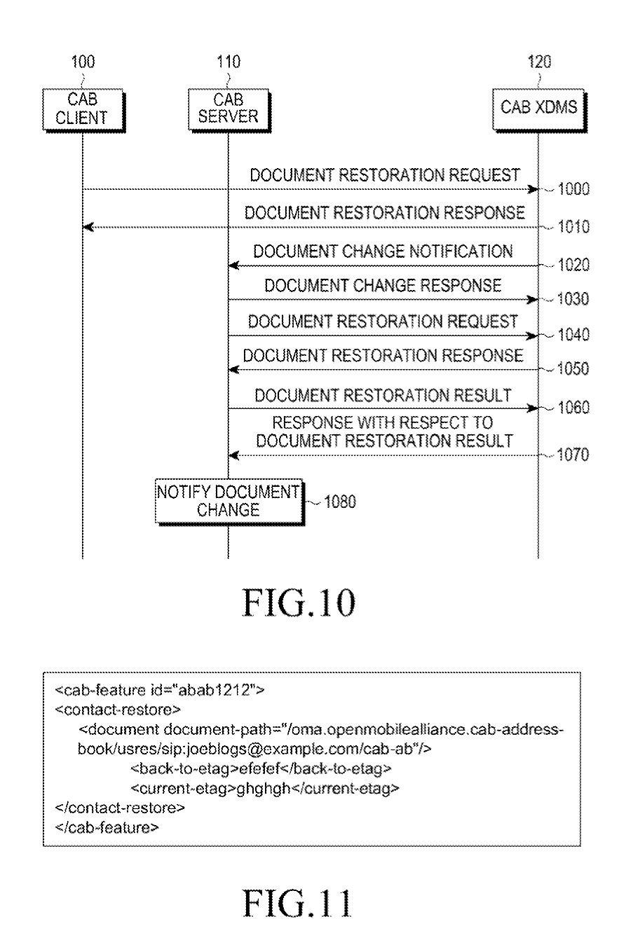

First, a document restoration process according to an embodiment of the present invention is described with reference to FIG. 10. FIG. 10 illustrates an example of a document restoration method using version information of a deleted document, acquired from a modification history information document as illustrated in FIG. 9.

Referring to FIG. 10, the CAB client 100 receives user's selection of a restoration target document from a deleted-document list based on acquired version information of a deleted document. The CAB client 100 then sends a document restoration request based on version information of the selected restoration target document to the CAB FH Application Usage of the CAB XDMS 120 in Step 1000. For the document restoration request, an XML Configuration Access Protocol (XCAP) request message is used.

Thus, the CAB FH Application Usage of the CAB XDMS 120 stores the received XCAP request message, and sends a document restoration response to the CAB client 100 by using a response message 200 OK in Step 1010. An example of the XCAP request message for the document restoration request stored in the CAB FH Application Usage is illustrated in FIG. 11.

FIG. 11 newly defines a <contact-restore> element to cause the CAB FH Application Usage to generate the document restoration request, and additionally defines a document path of the restoration target document based on the modification history information document, version information of the restoration target document, and current document version information of the restoration target document.

The CAB FH Application Usage, upon receiving the document restoration request, notifies a contact restore function in the CAB server 110 of document change of the CAB FH in Step 1020. Notification regarding the document change includes data defined in the document restoration request received in Step 1000. That is, the document change information includes information relating to the restoration target document, which is identical to information included in the document restoration request from the client. The data defined in the document restoration request is updated in the CAB FH Application Usage when the document restoration request is received in Step 1000, and the information included in the document restoration request is recognized as the document change information and notified to the CAB server 110. Aside from the notification regarding the document change by the CAB FH Application Usage, the contact restoration function of the CAB server 110 directly checks periodically if the document restoration request message is stored in the CAB FH Application Usage, thus acquiring the document change information of the CAB FH.

The contact restoration function of the CAB server 110 sends the response message 200 OK regarding the document change notification to the CAB FH Application Usage of the CAB XDMS 120 in Step 1030. The response message includes a document change version changed by a corresponding update.

As such, by acquiring the document change information, the CAB server 110 can recognize that document restoration is requested by the CAB client 100, and can also acquire the data defined in the document restoration request. Based on the document change information, the contact restoration function of the CAB server 110 requests document restoration from the AB Application Usage of the CAB XDMS 120 in Step 1040.

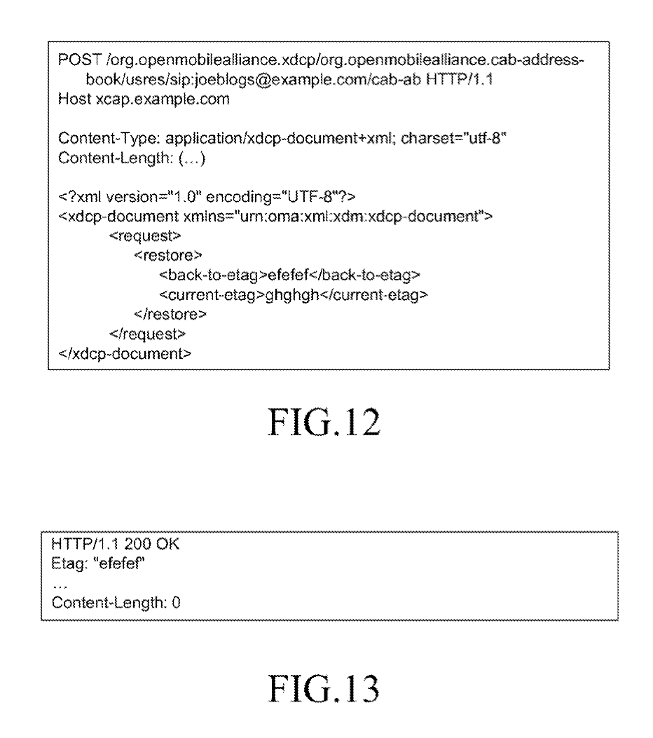

For example, as illustrated in FIG. 11, address information of “joeblogs” is included in the document path of the restoration target document, and the contact restoration function of the CAB server 110 requests restoration of the address information of “joeblogs” deleted from the AB Application Usage of the CAB XDMS 120 by using the XDCP. An example of the XDCP request message for the document restoration request is illustrated in FIG. 12. Herein, if the XCAP request message indicates basic operations (Put, Delete, Get) for XML document management, then the XDCP request message is a message for indicating additional XML document management operations (Restore, Forward, etc.).

Referring to FIG. 12, the XDCP request message for the document restoration request includes document restoration information regarding a restoration target document, e.g., a path URI of the restoration target document, current document version information of the restoration target document, and document version information to be restored of the restoration target document, like the data defined in the document restoration request in FIG. 11, but in a different format.

The AB Application Usage of the CAB XDMS 120 restores the restoration target document based on the document restoration information included in the XDCP request message, e.g., the document version information, and then transmits the response message 200 OK to the CAB server 110 in Step 1050. An example of the response message is illustrated in FIG. 13.

The contact restoration function of the CAB server 110 stores a document restoration result in the CAB FH Application Usage of the CAB XDMS 120 in Step 1060. Upon receiving a response message regarding the document restoration result in Step 1070, the CAB server 110 sends a notification message including document change occurring in the AB Application Usage for document synchronization, e.g., address book synchronization, to the CAB client 100 in Step 1080.

The document restoration method using the CAB FH Application Usage according to an embodiment of the present invention is almost similarly applied to restoration of PCC information handled in a CAB environment and other XML documents requiring restoration in the CAB XDMS 120. For example, when deleted PCC information is restored, the document restoration request message includes information indicating a particular PCC in the CAB XDMS 120 as a target of the document restoration request message, version information to be restored, and current document version information.

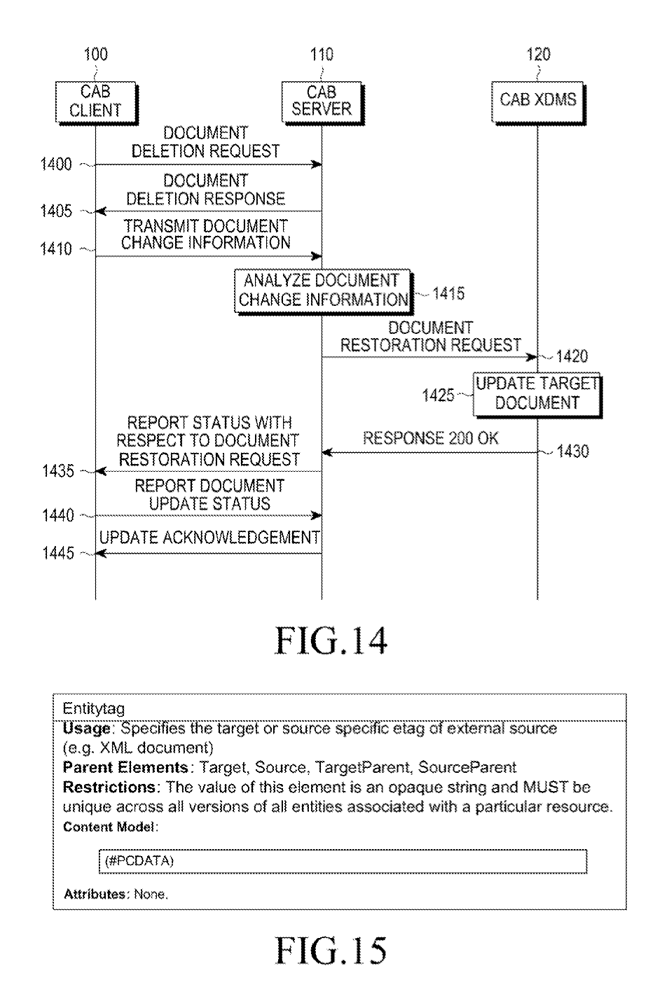

A document restoration process according to an embodiment of the present invention is described with reference to FIG. 14. The document restoration process is performed using the CAB FH Application Usage and may alternatively be performed using the DS protocol.

Referring to FIG. 14, Steps 1400 and 1405 are the same as Steps 300 and 305 of FIG. 3 and thus will not be described in detail. However, in Step 1410, the CAB client 100 generates a document replacement request from the acquired modification history document information based on current document version information new-etag=“ghghgh” and previous document version information previous-etag=“efefef,” and sends the generated document replacement request to the CAB server 110. The current document version information “ghghgh” indicates document information at the current point in time after deletion, and thereafter, for document restoration, the document restoration is requested by using document information at a point in time for restoration, e.g., “efefef,” and the deleted document information “ghghgh.”

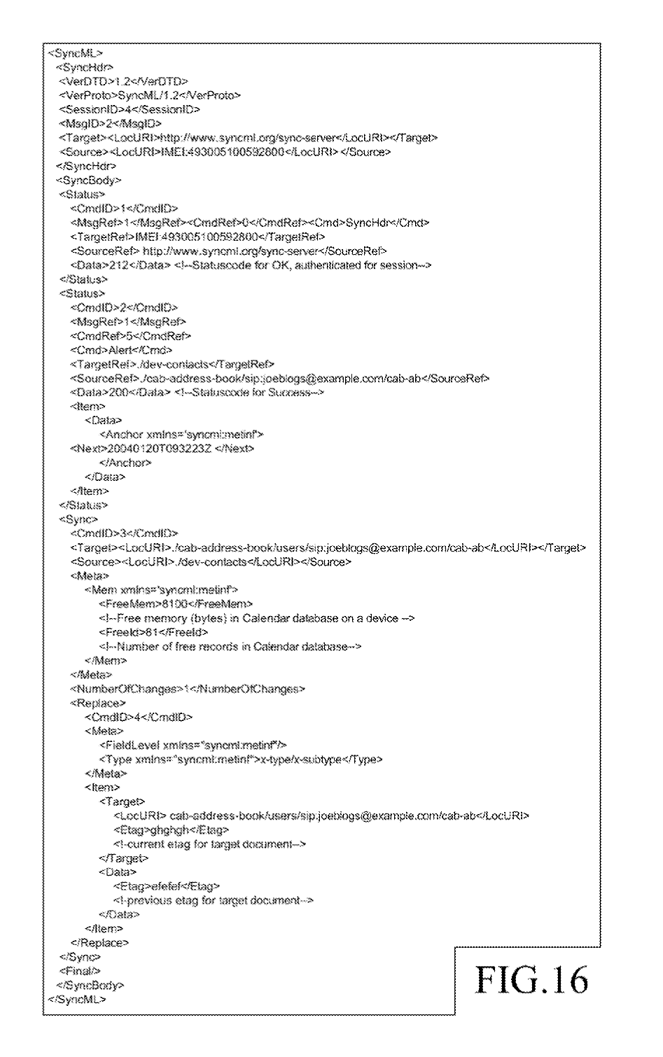

For the document replacement request in Step 1410, a DS message OMA DS Pkg #3 is used. The DS message for the document replacement request newly defines a new common element “Etag” indicating document version information “entity tag” of a resource generated in an external server, e.g., an XML document, in a transmission or reception address element included in a status element. Details of the “Etag” element are as illustrated in FIG. 15. An example of the DS message in which the “Etag” element is defined is illustrated in FIG. 16.

FIG. 16 illustrates details of the DS message for restoring the deleted document. As illustrated in FIG. 16, the DS message includes a path of a restoration target document, current document version information of the restoration target document, and document version information to be restored of the restoration target document, that is, previous document version information previous-etag=“efefef.”

The CAB server 110, after analyzing information included in the DS message for the document replacement request from the CAB client 100 in Step 1415, requests restoration of the document deleted from the AB Application Usage of the CAB XDMS 120 based on the analysis in Step 1420. For the document restoration request, an XDCP request message is used, and Step 1420 is the same as Step 1040 of FIG. 10 except that the XDCP request message of Step 1420 further includes an “Etag” element. If the DS message includes a plurality of address change requests, a change request message would be generated using an XCAP for each address change request. The AB Application Usage of the CAB XDMS 120 restores a restoration target document by referring to the “Etag” element of the received XDCP request message in Step 1425, and then transmits a response message 200 OK to the CAB server 110 in Step 1430. Step 1430 is the same as Step 1050 of FIG. 10.

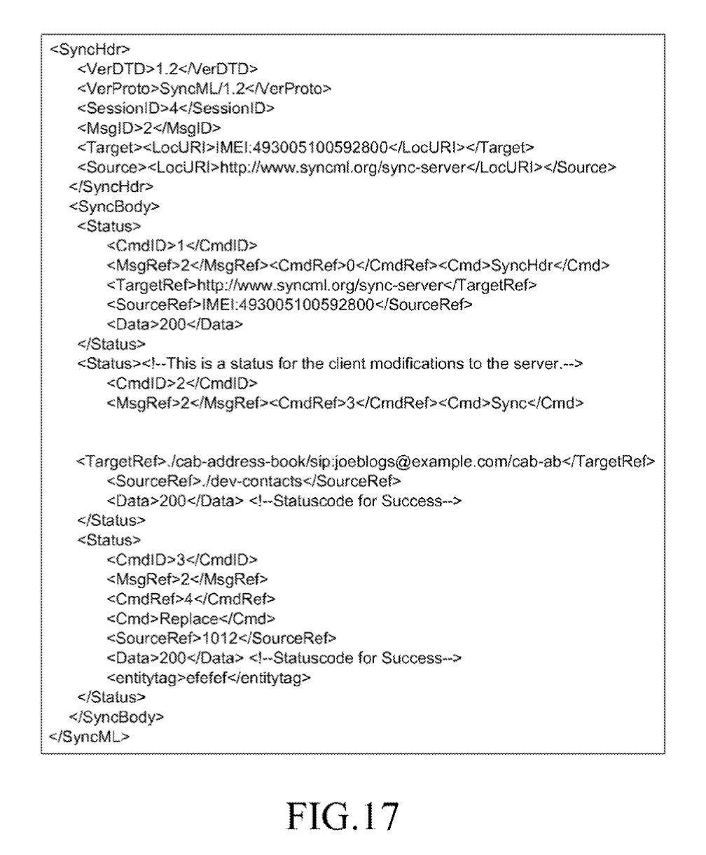

The CAB server 110 reports the CAB client 100 of a status regarding the document restoration request in Step 1435. The DS message OMA DS Pkg #4 including status information regarding the document restoration request of the CAB client 100 is transmitted. The status information regarding the document restoration request includes a version “entitytag” of a document restored in the AB Application Usage. Version information of the restored document is forwarded to the CAB client 100, and the CAB user restores the deleted document information by using the version information when the CAB user desires to restore the document information. An example of the DS message including the status information regarding the document restoration request is illustrated in FIG. 17.

As illustrated in FIG. 17, the DS message including the status information expresses with a status code “200” that a command the CAB client requests for a document “1012,” that is, “Replace” has been successfully executed, and includes the status information indicating that document version after restoration, “entitytag” is “efefef.”

Operations in Steps 1440 and 1445 are the same as those in Steps 335 and 340 of FIG. 3.

By providing a document restoration method using a DS protocol, easy and rapid document restoration is possible. Moreover, document restoration is possible without a separate auxiliary repository, thereby preventing waste of resources, power, and memories. Additionally, the user can delete and easily restore address information, and thus the user is provided with a more convenient CAB environment.

It will be apparent to those of ordinary skill in the art that embodiments of the present invention can be implemented in the form of hardware, software or a combination of hardware and software. For example, the software may be stored in the form of volatile or non-volatile storage such as, for example, a storage device like a Read-Only Memory (ROM), or in the form of memory such as, for example, Random Access Memory (RAM), memory chips, device or integrated circuits or on an optically or magnetically readable medium such as, for example, a Compact Disk (CD), Digital Versatile Disk (DVD), magnetic disk or magnetic tape or the like. A storage unit included in a client terminal is an example of a machine-readable storage medium suitable for storing programs with coded instructions for implementing an apparatus and method described herein, and a machine-readable storage medium storing such a program. Such programs may be conveyed electronically via any medium such as a communication signal carried over a wired or wireless connection.

Furthermore, the client terminal may receive and store the program from a program providing device connected in a wired or wireless manner. The program providing device may include a memory for storing a program including instructions for the client terminal to execute a preset document restoration method and information necessary for the document restoration method, a communication unit for performing wired or wireless communication with the client terminal, and a controller for transmitting a corresponding program to the client terminal at the request of the device or automatically.

While the present invention has been described with reference to various embodiments thereof, various modifications can be made without departing from the spirit and scope of the present invention, as defined by the appended claims and their equivalents.

What is claimed is:

1. A document restoration method by a Converged Address Book (CAB) server, the document restoration method comprising:
acquiring document change information from a CAB document management server in response to a document restoration request by a client;
determining a restoration target document based on the acquired document change information; and
restoring a deleted document in the CAB document management server by providing the document restoration request for the determined restoration target document to the CAB document management server.

2. The document restoration method of claim 1, wherein the document change information comprises restoration target document information, included in the document restoration request by the client.

3. The document restoration method of claim 1, wherein the document restoration request by the client comprises at least one of a path of the restoration target document, version information of the restoration target document, and current document version information of the restoration target document.

4. The document restoration method of claim 1, wherein the document restoration request by the client is forwarded to the CAB document management server from the client by using an Extensible Markup Language (XML) Configuration Access Protocol (XCAP) request message.

5. The document restoration method of claim 1, wherein the document restoration request by the client is updated and stored in a CAB Feature Handler (FH) Application Usage of the CAB document management server.

6. The document restoration method of claim 1, further comprising providing, by the CAB server, document version information of a deleted document to the client in response to the document restoration request by the client.

7. The document restoration method of claim 1, further comprising upon receiving a response message from the CAB document management server after completed restoration of a deleted document in the CAB document management server, storing a document restoration result in the CAB document management server.

8. The document restoration method of claim 7, further comprising upon receiving a response message regarding storage of the document restoration result from the CAB document management server, transmitting a notification message for document synchronization to the client.

9. The document restoration method of claim 1, wherein the document restoration request for the determined restoration target document comprises at least one of a path of the restoration target document, current document version information of the restoration target document, and document version information to be restored of the restoration target document.

10. The document restoration method of claim 1, wherein the document restoration request for the determined restoration target document is forwarded to the CAB document management server by using an Extensible Markup Language (XML) Document Command Protocol (XDCP) request message.

11. A Converged Address Book (CAB) client terminal for document restoration, the CAB client terminal comprising:
a storage unit for storing a deleted-document list comprising version information of at least one deleted document; and
a controller for acquiring version information of the at least one deleted document from a CAB server upon a document deletion request, storing the acquired version information, and upon selection of a restoration target document from the stored deleted-document list, transmitting a document restoration request to the CAB document management server for the CAB server to restore the selected restoration target document in the CAB document management server.

12. The CAB client terminal of claim 11, wherein the document restoration request comprises at least one of a path of the restoration target document, version information of the restoration target document, and current document version information of the restoration target document.

13. The CAB client terminal of claim 11, wherein the document restoration request is forwarded to the CAB document management server by using an Extensible Markup Language (XML) Configuration Access Protocol (XCAP) request message.

14. The CAB client terminal of claim 13, wherein the document restoration request is updated and stored in a CAB Feature Handler (FH) Application Usage of the CAB document management server.

15. The CAB client terminal of claim 11, wherein the controller, when using a Data Synchronization (DS) protocol message, forwards a document replacement request to the CAB server to restore the selected restoration target document.

16. The CAB client terminal of claim 15, wherein the document replacement request comprises at least one of a path of the restoration target document, current document version information of the restoration target document, and document version information to be restored of the restoration target document.
